(19) United States
(12) Patent Application Publication
(10) Pub. No.: US 2026/0259101 A1
(43) Pub. Date: Sep. 3, 2026

(54) WIRELESS NITROGEN TEST DEVICE TO TEST AIR CONDITIONING UNITS FOR LEAKS

(71) Applicant: Stephen Merkley, San Tan Valley, AZ (US)

(72) Inventor: Stephen Merkley, San Tan Valley, AZ (US)

(21) Appl. No.: 19/068,864

(22) Filed: Mar. 3, 2025

(51) Int. Cl. G01M 3/26; F24F 11/36

(52) U.S. Cl. CPC G01M 3/26; F24F 11/36

(57) ABSTRACT

A wireless nitrogen test device to test air conditioning units for leaks includes a housing, an inlet valve, and an outlet valve. The inlet valve includes a first inlet pipe fitting is designed to connect the inlet valve to a nitrogen tank, and a second inlet pipe fitting is designed to connect the inlet valve to an air conditioning unit. The outlet valve includes a first outlet pipe fitting to release nitrogen, and a second outlet pipe fitting to connect the outlet valve to the air conditioning unit. The electronic control board is positioned in the housing. The electronic control board includes a wireless transceiver. The electronic control board electrically opens and closes the inlet and outlet valves. A battery is connected to the electronic control board, the inlet valve, and the outlet valve to supply power to the electronic control board, the inlet valve, and the outlet valve.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to nitrogen test devices and more particularly pertains to a new wireless nitrogen test device for allowing a user, such as a HVAC (heating ventilation and air conditioning) technician, to conduct leak tests at a location remote from the nitrogen supply. In a nitrogen test, a valve unit is connected to a nitrogen tank and then connected to a compressor of an air conditioning unit. The HVAC technician then starts checking for leaks in the pipes of the air conditioning unit. To perform the nitrogen testing, the HVAC technician has to routinely turn the nitrogen flow on and off, as is well known in the HVAC industry. This can be done either by having a separate HVAC technician turn the nitrogen on and off, which thereby doubles the service work time and costs, or by a single HVAC technician, who has to waste time walking back and forth to the valve unit. The wireless nitrogen test device permits a single HVAC technician to conduct the testing at any location a distance from the valve unit by enabling the HVAC technician to remotely turn the nitrogen flow on and off as needed.

### (2) Description of Related Art Including Information Disclosed Under 37 CFR 1.97 and 1.98

The prior art relates to nitrogen test devices. The prior art, as best understood, does not disclose a wireless nitrogen test device that has remotely controllable inlet and outlet valves to allow the a user to control the flow of nitrogen into and out of the air conditioning unit while conducting leak tests.

### (h) BRIEF SUMMARY OF THE INVENTION

An embodiment of the disclosure meets the needs presented above in a wireless nitrogen test device generally comprising a housing, an inlet valve, and an outlet valve. The inlet valve is attached to the housing. The inlet valve includes a first inlet pipe fitting designed to connect the inlet valve to a nitrogen tank. The inlet valve includes a second inlet pipe fitting designed to connect the inlet valve to an air conditioning unit. The outlet valve is attached to the housing. The outlet valve includes a first outlet pipe fitting to release nitrogen into surrounding air. The outlet valve includes a second outlet pipe fitting to connect the outlet valve to the air conditioning unit. An electronic control board is positioned in the housing. The electronic control board includes a wireless transceiver designed to receive control signals from a remote device. The electronic control board is connected to the inlet valve and the outlet valve to electrically open and close the inlet valve and the outlet valve. A battery is positioned in the housing. The battery is connected to the electronic control board, the inlet valve, and the outlet valve to supply power to the electronic control board, the inlet valve, and the outlet valve.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a wireless nitrogen test device according to an embodiment of the disclosure.

FIG. 2 is a rear view of an embodiment of the disclosure.

FIG. 3 is a top view of an embodiment of the disclosure.

FIG. 4 is a bottom view of an embodiment of the disclosure.

FIG. 5 is a bottom interior view of an embodiment of the disclosure.

FIG. 6 is a top view of a remote unit of an embodiment of the disclosure.

FIG. 7 is a perspective view of an embodiment of the disclosure in use.

FIG. 8 is a schematic view of an embodiment of the disclosure in use.

### (j) DETAILED DESCRIPTION OF THE INVENTION

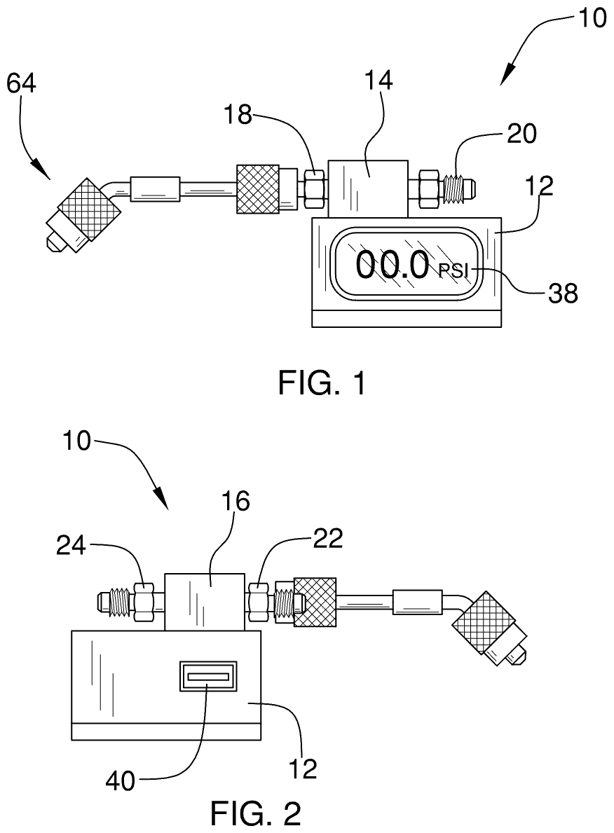

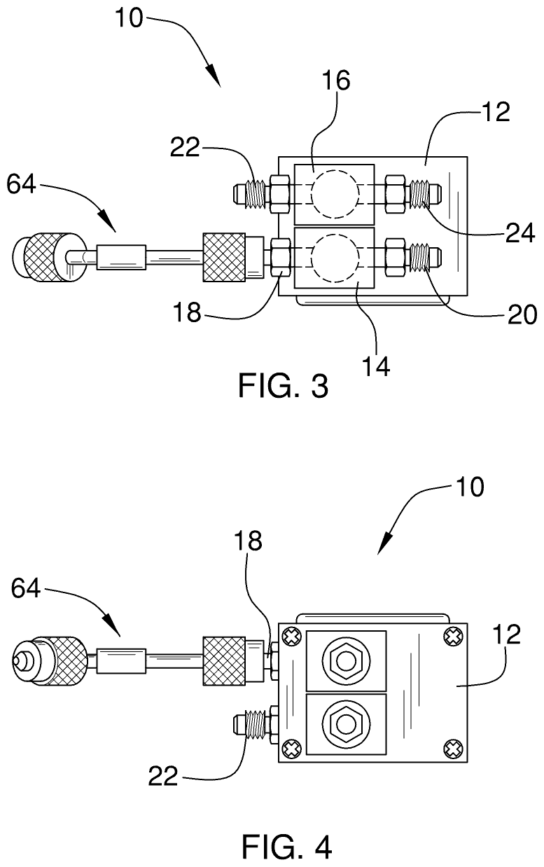

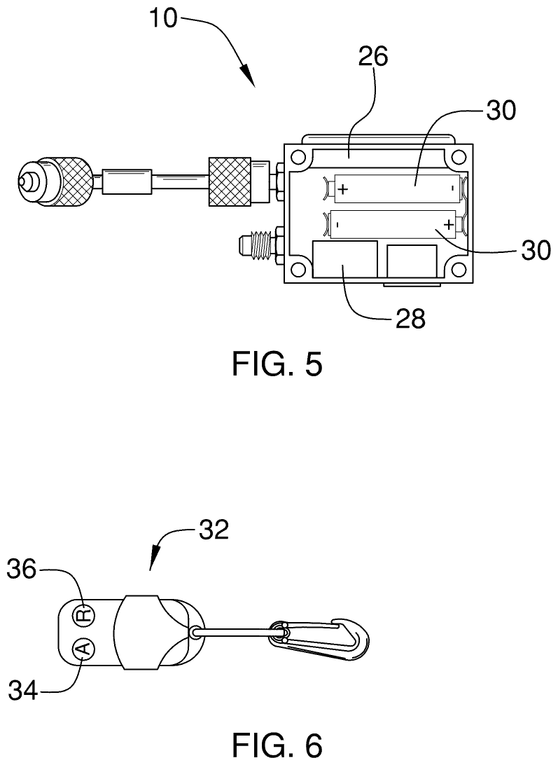

With reference now to the drawings, and in particular to FIGS. 1 through 8 thereof, a new wireless nitrogen test device embodying the principles and concepts of an embodiment of the disclosure and generally designated by the reference numeral 10 will be described.

As best illustrated in FIGS. 1 through 8, the wireless nitrogen test device 10 generally comprises a housing 12, an inlet valve 14, and an outlet valve 16. The inlet valve 14 is attached to the housing 12. The inlet valve 14 includes a first inlet pipe fitting 18 designed to connect the inlet valve 14 to a nitrogen tank 60. The inlet valve 14 includes a second inlet pipe fitting 20 designed to connect the inlet valve 14 to an air conditioning unit 62. The outlet valve 16 is attached to the housing 12. The outlet valve 16 includes a first outlet pipe fitting 22 to release nitrogen, such as into the surrounding environment. The outlet valve 16 includes a second outlet pipe fitting 24 to connect the outlet valve 16 to the air conditioning unit 62. An electronic control board 26 is positioned in the housing 12. The electronic control board 26 includes a wireless transceiver 28 is designed to receive control signals from a remote device. The electronic control board 26 is connected to the inlet valve 14 and the outlet valve 16 to electrically open and close the inlet valve 14 and the outlet valve 16. A battery 30 is positioned in the housing 12. The battery 30 is connected to the electronic control board 26, the inlet valve 14, and the outlet valve 16 to supply power to the electronic control board 26, the inlet valve 14, and the outlet valve 16.

As shown in FIG. 1, in the exemplary embodiment, a hose fitting 64 is detachably connected to the first inlet pipe fitting 18 to allow for quick and easy connection to a hose to the nitrogen tank 60. However, any suitable hose fitting could be utilized as is well known in the air conditioning arts.

As shown in FIG. 6, the wireless nitrogen test device 10 further includes a wireless remote control 32. The wireless remote control 32 includes a first button 34 designed to be engaged to open the inlet valve 14 to add nitrogen to the air conditioning unit 62 and to close the inlet valve 14, and a second button 36 designed to be engaged to open the outlet valve 16 to remove nitrogen from the air conditioning unit 62 and to close the outlet valve 16.

As shown in FIG. 1, the wireless nitrogen test device 10 further includes a digital pressure gauge 38 attached to the housing 12. The digital pressure gauge 38 is connected to the inlet valve 14 and the outlet valve 16 to detect and display pressure of the nitrogen.

As shown in FIG. 2, the wireless nitrogen test device 10 further includes a charging port 40. The battery 30 is rechargeable. The charging port 40 is positioned in a side of the housing 12 and connected to the battery 30. The charging port 40 can be a USB-style charging port.

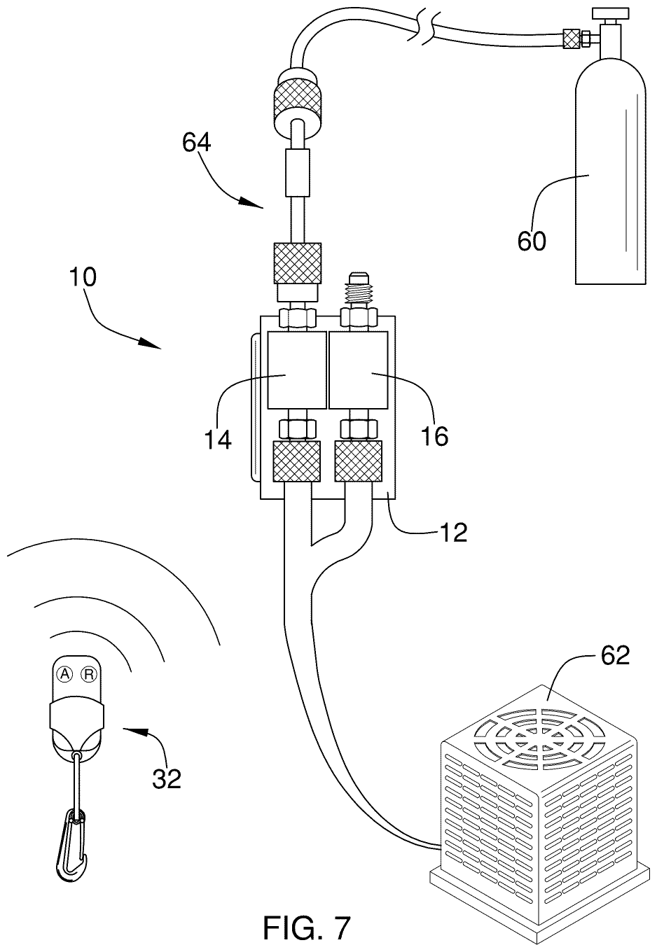

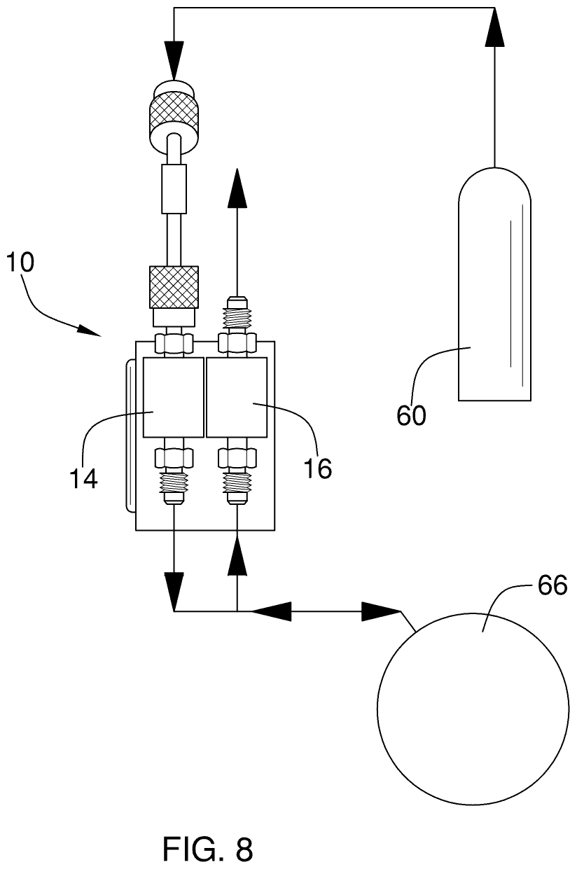

The wireless nitrogen test device 10 is used to test for and fix leaks in an air conditioning unit 62. A user first connects the wireless nitrogen test device 10 to a nitrogen tank 60, and then connects the wireless nitrogen test device 10 to a compressor 66 of the air conditioning unit 62, as shown in a representative manner in FIGS. 7 and 8. The user then goes over to the air conditioning unit 62, at which time the user remotely opens the inlet valve 14 and adds nitrogen into the air conditioning unit 62 while monitoring pipes of the air conditioning unit 62 for leaks. After the user discovers a leak, the user remotely closes the inlet valve 14 and remotely opens the outlet valve 16 and removes nitrogen from the air conditioning unit 62. The user fixes the leak. The user then remotely closes the outlet valve 16. The user then remotely opens the inlet valve 14 and adds nitrogen into the air conditioning unit 62 in order to pressure test the air conditioning unit 62 to determine if the leak has been fixed successfully. The user can repeat the preceding steps until all leaks are fixed without having to walk back and forth to turn the nitrogen flow on and off or rely on a second user to do that task.

In the exemplary embodiment, the wireless remote control 32 is designed such that the user presses and holds the first button 34 to remotely open and hold open the inlet valve 14, and then releases the first button 34 to close the inlet valve 14. This allows the user to control how much nitrogen is flowed into the air conditioning unit 62. The second button 36 can function similarly, wherein the user presses and holds the second button 36 to remotely open and hold open the outlet valve 16, and then releases the second button 36 to close the outlet valve 16. In another possible embodiment, the wireless remote control 32 could operate differently, such as using multiple presses to open and close the inlet valve 14 or outlet valve 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wireless nitrogen test device to test air conditioning units for leaks comprising:
a housing;
an inlet valve being attached to said housing, said inlet valve including a first inlet pipe fitting being configured to connect said inlet valve to a nitrogen tank, said inlet valve including a second inlet pipe fitting being configured to connect said inlet valve to an air conditioning unit;
an outlet valve being attached to said housing said outlet valve including a first outlet pipe fitting being configured to release nitrogen, said outlet valve including a second outlet pipe fitting being configured to connect said outlet valve to the air conditioning unit;
an electronic control board being positioned in said housing, said electronic control board including a wireless transceiver being configured to receive control signals from a remote device, said electronic control board being connected to said inlet valve and said outlet valve to electrically open and close said inlet valve and said outlet valve; and
a battery being positioned in said housing, said battery being connected to said electronic control board, said inlet valve, and said outlet valve to supply power to said electronic control board, said inlet valve, and said outlet valve.

2. The wireless nitrogen test device of claim 1, further comprising a wireless remote control, wherein said wireless remote control includes:
a first button configured to be engaged to open said inlet valve to add nitrogen to the air conditioning unit and to close said inlet valve; and
a second button configured to be engaged to open said outlet valve to remove nitrogen from the air conditioning unit and to close said outlet valve.

3. The wireless nitrogen test device of claim 1, further comprising a digital pressure gauge attached to said housing, wherein said digital pressure gauge is connected to said inlet valve and said outlet valve to detect and display pressure of the nitrogen.

4. The wireless nitrogen test device of claim 1, further comprising a charging port, wherein:
said battery is rechargeable; and
said charging port is positioned in a side of said housing and connected to said battery.

5. The wireless nitrogen test device of claim 2, further comprising a digital pressure gauge attached to said housing, wherein said digital pressure gauge is connected to said inlet valve and said outlet valve to detect and display pressure of the nitrogen.

6. The wireless nitrogen test device of claim 5, further comprising a charging port, wherein:
said battery is rechargeable; and
said charging port is positioned in a side of said housing and connected to said battery.

7. A method of testing for and fixing leaks in an air conditioning unit, said method comprising the steps of:
providing a wireless nitrogen test device comprising:
a housing;
an inlet valve being attached to said housing, said inlet valve including a first inlet pipe fitting being configured to connect said inlet valve to a nitrogen tank, said inlet valve including a second inlet pipe fitting being configured to connect said inlet valve to an air conditioning unit;
an outlet valve being attached to said housing said outlet valve including a first outlet pipe fitting to release nitrogen into surrounding air, said outlet valve including a second outlet pipe fitting to connect said outlet valve to the air conditioning unit;
an electronic control board being positioned in said housing, said electronic control board including a wireless transceiver being configured to receive control signals from a remote device, said electronic control board being connected to said inlet valve and said outlet valve to electrically open and close said inlet valve and said outlet valve; and
a battery being positioned in said housing, said battery being connected to said electronic control board, said inlet valve, and said outlet valve to supply power to said electronic control board, said inlet valve, and said outlet valve;
connecting said wireless nitrogen test device to a nitrogen tank;
remotely opening said inlet valve and adding nitrogen into the air conditioning unit while monitoring pipes of the air conditioning unit for leaks;
discovering a leak;
remotely closing said inlet valve;
remotely opening said outlet valve and removing nitrogen from the air conditioning unit;
fixing the leak;
remotely closing said outlet valve;
remotely opening said inlet valve and adding nitrogen into the air conditioning unit; and
pressure testing the air conditioning unit to determine if the leak has been fixed successfully.

8. The method of claim 7, further comprising:
providing a wireless remote control comprising a first button and a second button;
said step of remotely opening said inlet valve includes pressing and holding said first button;
said step of remotely closing said inlet valve includes releasing said first button;
said step of remotely opening said outlet valve includes pressing and holding said second button; and
said step of remotely closing said outlet valve includes releasing said second button.
